(19) United States
(12) Patent Application Publication
(10) Pub. No.: US 2006/0136178 A1
(43) Pub. Date: Jun. 22, 2006

(54) Linear discriminant analysis apparatus and method for noisy environments

(76) Inventor: Young Joon Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/300,222

(22) Filed: Dec. 14, 2005

(30) Foreign Application Priority Data
Dec. 21, 2004 (KR) 2004-109896
Jul. 7, 2005 (KR) 2005-061156

(51) Int. Cl. G06F 15/00

(52) U.S. Cl. 702/191

(57) ABSTRACT

A linear discriminant analysis apparatus and method for noisy environments is provided. The apparatus includes: a noise environment model creator for creating various noise environment models from an input voice; a linear transformation matrix creator for creating linear transformation matrices from and at each of the created noise environment models; and a noise model estimator for estimating a noise model using the created linear transformation matrices, and creating a new linear transformation matrix.

### BACKGROUND OF THE INVENITON

1. Field of the Invention

The present invention relates to a linear discriminant analysis apparatus and method for noisy environments, and more particularly, to a linear discriminant analysis apparatus and method for noisy environments, for obtaining an optimal linear discriminant analysis transformation matrix adapted to a test environment, using a linear combination of matrices for a conventional environment noise, in actual test noisy environments in consideration of an environmental difference, thereby improving a test performance.

2. Description of the Related Art

In general, a linear discriminant analysis method is performed by obtaining a matrix where a within scatter matrix is minimized and concurrently, a total scatter matrix is maximized. This method starts from a process of dividing learning data into several classes by a specific reference, and obtaining the within scatter matrix and the total scatter matrix using an average and the number of samples of each class (it is assumed that a dispersion matrix is the same in all classes).

First, the within scatter matrix is obtained by the following Equation 1:

$${S}_{W} = {\sum }_{i = 1}^{L} {\sum }_{{{x}^{->}}_{k} ∈ {X}_{i}} ( {{x}^{->}}_{k} - {{m}^{->}}_{i} ) {( {{x}^{->}}_{k} - {{m}^{->}}_{i} )}^{T} \qquad [ Equation 1 ]$$

Next, the total scatter matrix is obtained by the following Equation 2:

$${S}_{T} = {\sum }_{i = 1}^{L} {n}_{i} ( {{m}^{->}}_{i} - {m}^{->} ) {( {{m}^{->}}_{i} - {{m}^{->}}_{i} )}^{T} \qquad [ Equation 2 ]$$

where,
\vec{m}ᵢ: average of the class Xᵢ, and
nᵢ: number of samples of the class Xᵢ.

A partial space of the linear discriminant analysis method is achieved by a span of a vector set (W) satisfying the following Equation 3:

$$W = arg max \vert \frac{{W}^{T} {S}_{T} W}{{W}^{T} {S}_{W} W} \vert \qquad [ Equation 3 ]$$

Therefore, the vector set (W) satisfying the Equation 2 can be obtained by obtaining an inherence vector of S_{W}⁻¹S_{T}.

The inherent vector of the S_{W}⁻¹S_{T} can be obtained by performing a simultaneous diagonalization of the S_{W} and the S_{T}.

The simultaneous diagonalization is performed as follows.

First, an inherent value matrix (S_{W}) and an inherent vector matrix Θ of Φ are obtained.

Second, a center of the class is projected with an axis of

$${ΦΘ}^{- \frac{1}{2}} .$$

That is, the S_{T} is transformed to

$${K}_{T} = {Θ}^{- \frac{1}{2}} {Φ}^{T} {S}_{T} {ΦΘ}^{- \frac{1}{2}} .$$

Third, after an inherent value matrix (Λ) and an inherent vector matrix (Ψ) of the K_{T} are obtained, projection vectors of the linear discriminant analysis method are obtained as W=ΦΘ^{1/2}Ψ.

Further, the linear discriminant analysis method has several classes by several references. One of them is a class of the fog signal section. The class of the fog signal section can variously exist depending on an environment of data to be used for learning and an influence of a channel. However, in a conventional using method, a total fog signal section has been expected and used as only one class. Accordingly, a noisy environment used for the learning has a great difference from a noise environment used for a test.

In general, in the fog signal section, a noise added to a signal or a channel distortion exists in various types. Further, the various noises have influence even on classes of other data. As such, when influences from the various noises and channels are modeled as one class, and when influences from other classes distorted by the noise are modeled as one, it cannot be expected to accurately predict the model. There is a drawback in that a phenomenon of an erroneous dimension reduction is caused in the learning environment and the test environment.

Further, one of the classes of the linear discriminant analysis method is the fog signal section. However, the fog signal section shows a great difference between the learning data and the actual test data. There is a drawback in that such a difference of the classes causes erroneous transformation of the linear discriminant analysis method, thereby resulting in performance reduction.

As such, conventional technologies are concentrated on a method for well distinguishing a dimension with the class and endeavors for a little better expressing data, and a method for combining well adaptable characteristic vectors. However, in the conventional technologies, it is just only to use the transformation matrices obtained from the learning data, as it is, without considering the influence caused by the difference between the learning environment and the actual test environment.

In other words, there is a drawback in that the linear discriminant analysis method, which is a characteristic vector dimension reduction technique widely used in a field of signal processing, does not consider the noisy environments, thereby causing the erroneous dimension reduction and reducing the performance.

Further, in order to obtain the linear discriminant analysis transformation matrix, in general, the learning data is divided into several classes, and the within scatter matrix and the total scatter matrix for the classes are obtained. However, the signal inputted in the actual environment is mixed with the noise and has a value different from the within scatter matrices obtained through the learning data, thereby causing the erroneous dimension reduction.

### SUMMARY OF THE INVENTION

Accordingly, the present invention is directed to a linear discriminant analysis apparatus and method for noisy environments, which substantially obviates one or more problems due to limitations and disadvantages of the related art.

It is an object of the present invention to provide a linear discriminant analysis apparatus and method for noisy environments, for considering influences from an environmental difference and obtaining a linear transformation matrix, thereby obtaining the linear transformation matrix adapted to a test environment.

It is another object of the present invention to provide a linear discriminant analysis apparatus and method for noisy environments, for compensating for influence on a noise section and a difference of a fog signal section used for learning in an actual noisy environments, and reflecting the compensated influence and difference in an actually used transformation matrix, thereby seeking performance improvement in noisy environments.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a linear discriminant analysis apparatus for noisy environments, the apparatus including: a noise model estimator for estimating a noise model using linear transformation matrices previously created in a learning environment, and creating a new linear transformation matrix, in a test environment.

In another aspect of the present invention, there is provided a linear discriminant analysis method for noisy environments, the method including the step of: estimating a noise model using linear transformation matrices previously created in a learning environment, and creating a new linear transformation matrix, in a test environment.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 illustrates a construction of a matrix creator in learning environments applied to the present invention;

FIG. 2 illustrates a construction of a linear discriminant analysis apparatus for noisy environments according to an embodiment of the present invention;

FIG. 3 is a flowchart illustrating a linear discriminant analysis method for noisy environments according to an embodiment of the present invention; and

FIG. 4 is a detailed flowchart illustrating a noise model estimating step of FIG. 3.

### DETAILED DESCRIPTION OF THE INVENTION

Reference will now be made in detail to the preferred embodiments of the present invention, examples of which are illustrated in the accompanying drawings.

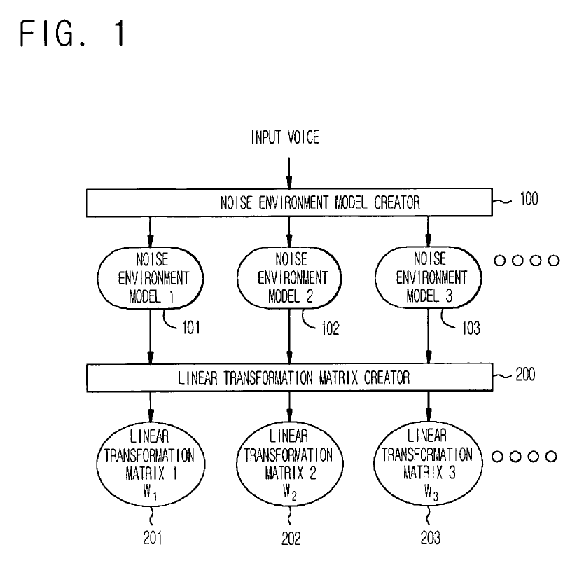

FIG. 1 illustrates a construction of a matrix creator in learning environments applied to the present invention.

As shown in FIG. 1, the matrix creator in the learning environments according to the present invention includes a noise environment model creator 100 for creating various noise environment models 101 to 103 from an input voice in the learning environments; and a linear transformation matrix creator 200 for creating linear transformation matrices 201 to 203 at each of the noise environment models 101 to 103 created in the noise environment model creator 100, in the learning environments. As such, the noise environment model creator 100 and the linear transformation matrix creator 200 are driven in the learning environments. Further, the present invention provides an apparatus and method where influence on a noise section and a difference of a fog signal section used for learning are compensated in actual noisy environments and the compensated influence and difference is reflected in an actually used transformation matrix, so as to improve a performance in the noisy environments.

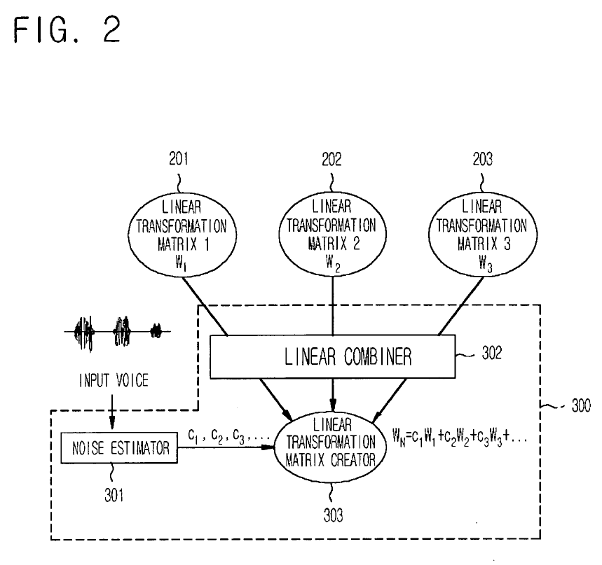

FIG. 2 illustrates a construction of a linear discriminant analysis apparatus for noisy environments according to an embodiment of the present invention.

As shown in FIG. 2, the inventive linear discriminant analysis apparatus includes a noise model estimator 300 for estimating a noise model using the linear transformation matrices 201 to 203 created in the linear transformation matrix creator 200, and creating a new linear transformation matrix, in a test environment.

The noise model estimator 300 includes a noise estimator 301 for estimating noise in the fog signal section of the input voice, and creating linear combination coefficients (c₁, c₂, c₃, . . . ); a linear combiner 302 for linearly combining the created linear transformation matrices 201 to 203; and a linear transformation matrix creator 303 for creating a new linear transformation matrix (W_{N}) using the created linear combination coefficients (c₁, c₂, c₃. . . ) and the combined linear transformation matrices 201 to 203.

The linear transformation matrix creator 303 multiplies the linearly combined linear transformation matrices 201 to 203 with the created linear combination coefficients (c₁, c₂, c₃, . . . ), respectively, and creates the new linear transformation matrix (W_{N}).

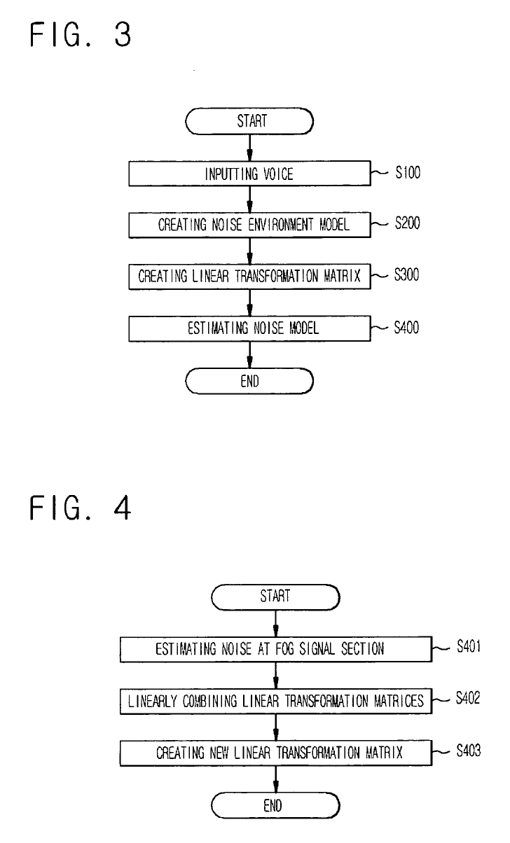

Thus, a linear discriminant analysis method for the noisy environments using the above-constructed linear discriminant analysis apparatus will be described with reference to FIGS. 3 and 4.

FIG. 3 is a flowchart illustrating the linear discriminant analysis method for the noisy environments according to an embodiment of the present invention.

As shown in FIG. 3, first, if voice is inputted in the learning environments (Step 100), the noise environment model creator 100 creates various noise models 101 to 103 from the inputted voice (Step 200). The linear transformation matrix creator 200 creates the linear transformation matrices 201 to 203 at each of the created noise models 101 to 103.

After that, in the test environment, the noise model estimator 300 estimates the noise model using the created linear transformation matrices 201 to 203, and creates the new linear transformation matrix (W_{N}) (Step 400). Hereinafter, the step of creating the linear transformation matrix (Step 400) will be in detail described in FIG. 4.

FIG. 4 is a detailed flowchart illustrating the noise model estimating step of FIG. 3.

As shown in FIG. 4, the noise estimator 301 estimates the noise of the fog signal section of the inputted voice, and creates the linear combination coefficients (c₁, c₂, c₃, . . . ) (Step 401). The linear combiner 302 linearly combines the linear transformation matrices 201 to 203 created in the linear transformation matrix creator 200 (Step 402).

As in the following Equation 4, the linear transformation matrix creator 303 multiplies the linear transformation matrices linearly combined in the linear combiner 302 with the linear combination coefficients (c₁, c₂, c₃, . . . ) created in the noise estimator 301, respectively, and creates the new linear transformation matrix (W_{N}).
W_{N}=c₁W₁+c₂W₂+c₃W₃+ . . . +c_{N}W_{N} [Equation 4]

As described above, the inventive linear discriminant analysis apparatus and method for the noisy environments can be used in all signal processing fields of using various characteristic vectors while obtaining a linear discriminant analysis (LDA) transformation matrix for reducing the dimension.

Further, in the linear discriminant analysis method, the difference from the class of the fog signal section obtained and learned from the noisy environments in an initial fog signal section can be compensated so as to reduce an effect of the erroneous dimension reduction caused by the difference between the learning environment and the test environment.

Furthermore, the present invention can seek the performance improvement by variously modeling the learning data for an environmental difference.

Additionally, the present invention can reflect the noise difference of the fog signal section between the test environment and the learning environment, on the fog signal section class depending on the noise data, thereby reflecting the difference between various noise classes on the linear discriminant analysis transformation matrix, and seeking the performance improvement.

Further, the present invention can achieve the dimension reduction using the linear discriminant analysis, in various noisy environments.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A linear discriminant analysis apparatus for noisy environments, the apparatus comprising:
a noise environment model creator for creating various noise environment models from an input voice;
a linear transformation matrix creator for creating linear transformation matrices from and at each of the created noise environment models; and
a noise model estimator for estimating a noise model using the created linear transformation matrices, and creating a new linear transformation matrix.

2. The apparatus of claim 1, wherein the noise environment model creator creates an N number of the noise environment models, and the linear transformation matrix creator creates an N number of the linear transformation matrices corresponding to the N number of the noise environment models (“N” is a natural number).

3. The apparatus of claim 1, wherein the noise model estimator comprises:
a noise estimator for estimating noise at a fog signal section of the input voice, and creating linear combination coefficients;
a linear combiner for linearly combining the created linear transformation matrices; and
a linear transformation matrix creator for creating a new linear transformation matrix usable in a test environment, using the created linear combination coefficients and the combined linear transformation matrix.

4. The apparatus of claim 3, wherein the linear transformation matrix creator is constructed to multiply the linearly combined linear transformation matrix with each of the created linear combination coefficients.

5. A linear discriminant analysis method for noisy environments, the method comprising:
a first step of, when voice is inputted, creating various noise environment models from the inputted voice;
a second step of creating linear transformation matrices at each of the created noise environment models; and
a third step of estimating a noise model using the linear transformation matrices created in the second step, and creating a new linear transformation matrix.

6. The method of claim 5, wherein the first step creates an N number of the noise environment models, and the second step creates an N number of the linear transformation matrices corresponding to the N number of the noise environment models (“N” is a natural number).

7. The method of claim 5, wherein the third step comprises the steps of:
estimating noise at a fog signal section of the inputted voice, and creating linear combination coefficients;
linearly combining the linear transformation matrices created in the second step; and
creating a new linear transformation matrix usable in a test environment, using the created linear combination coefficients and the linearly combined linear transformation matrix.

8. The method of claim 7, wherein the new linear transformation matrix is obtained by multiplying the combined linear transformation matrix with each of the created linear combination coefficients.

9. The method of claim 8, wherein the new linear transformation matrix is obtained from Equation:
W_{N}=c₁W₁+c₂W₂+c₃W₃+ . . . c_{N}W_{N}
where,
c₁, c₂, and c₃: created linear combination coefficients,
W: linear transformation matrix, and
N: natural number.
